(19) United States
(12) Patent Application Publication
(10) Pub. No.: US 2001/0025393 A1
(43) Pub. Date: Oct. 4, 2001

(54) Light pole Xmas decorator +

(76) Inventor: John Richard Nicolette, North Rose, NY (US)

Correspondence Address: JOHN RICHARD NICOLETTE, 11061 SALTER RD., NORTH ROSE, NY, 14516, US

(21) Appl. No.: 09/803,753

(22) Filed: Mar. 12, 2001

Related U.S. Application Data
(60) Provisional application No. 60/189,442, filed on Mar. 15, 2000.

(51) Int. Cl. E04D 13/076; A47L 1/06; B25J 1/00

(52) U.S. Cl. 15/105; 15/160; 15/121; 15/144.4; 15/220.1; 15/236.04; 15/245; 294/19.1

(57) ABSTRACT

A decorating and cleaning product which uses a unique latch attachment designed to efficiently hang decorative holiday items such as strings of Xmas Lights in high trees and other places with the use of an 11′ foot 3 locking telescopic pole and the screw on latch. This allows for the elimination of a ladder which can be a safety hazord, plus it expands holiday decorating through the use of the pole and latch attachment. Working in sync with the decorative end of the latch, is the open end gutter cleaning brush which depresses into the gutter while pulling the attached rope which at the same time opens the opposite decorative end to pick up small limbs, twigs and other items to discard. The secondary cleaning attachment is designed to screw into the same 11′ foot 3 section telescopic pole, which allows for the cleaning of high windows, walls and ceilings. This invention is made of rubber, soft cloth, plastic, wood and fiberglass making it safe, light and flexable and most importantly it does not conduct electrical current, so when using to hang strings of xmas lights it can be considered electrical shock proof.

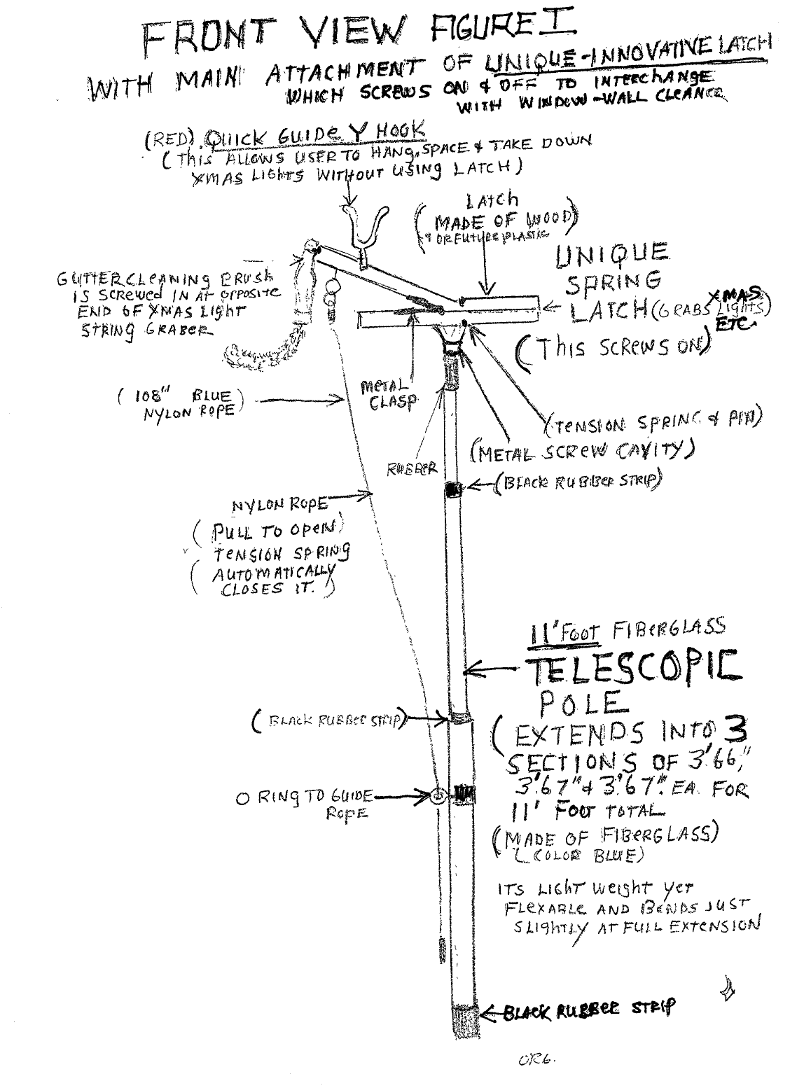

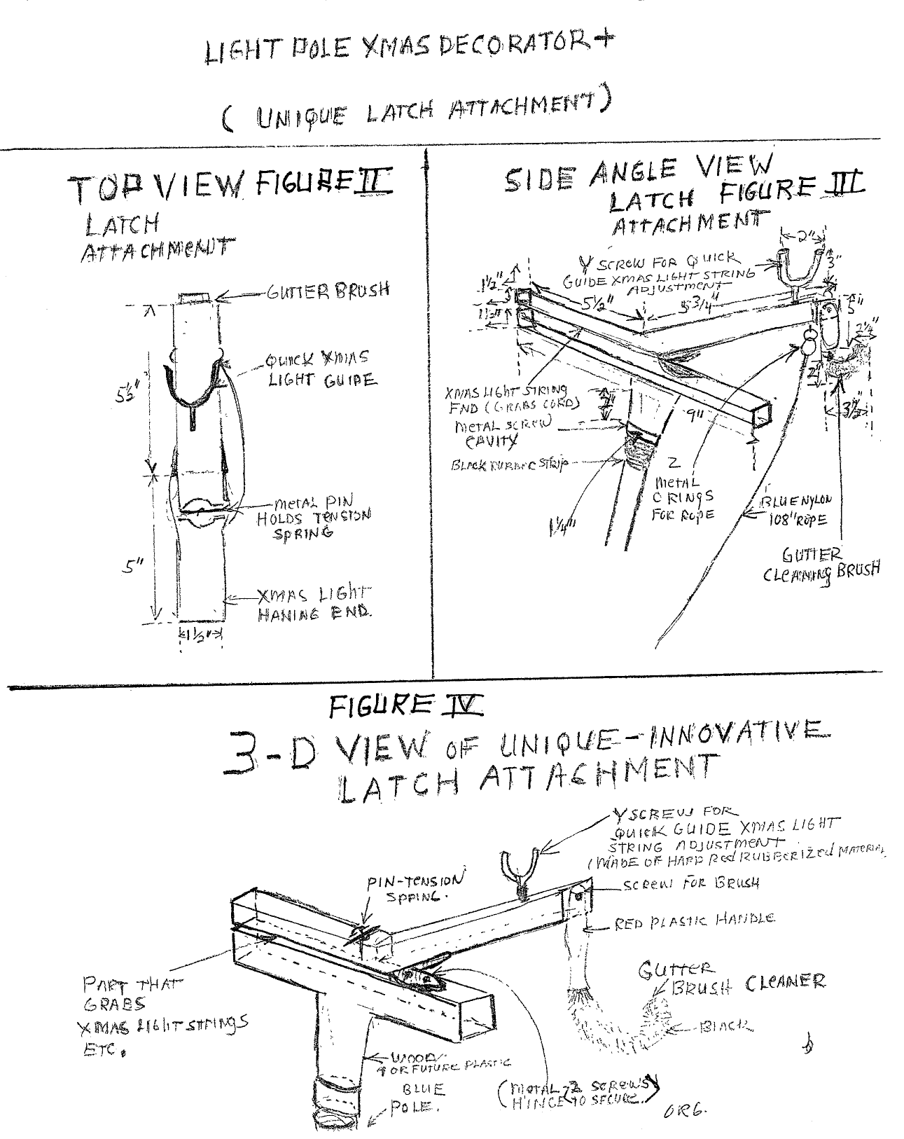

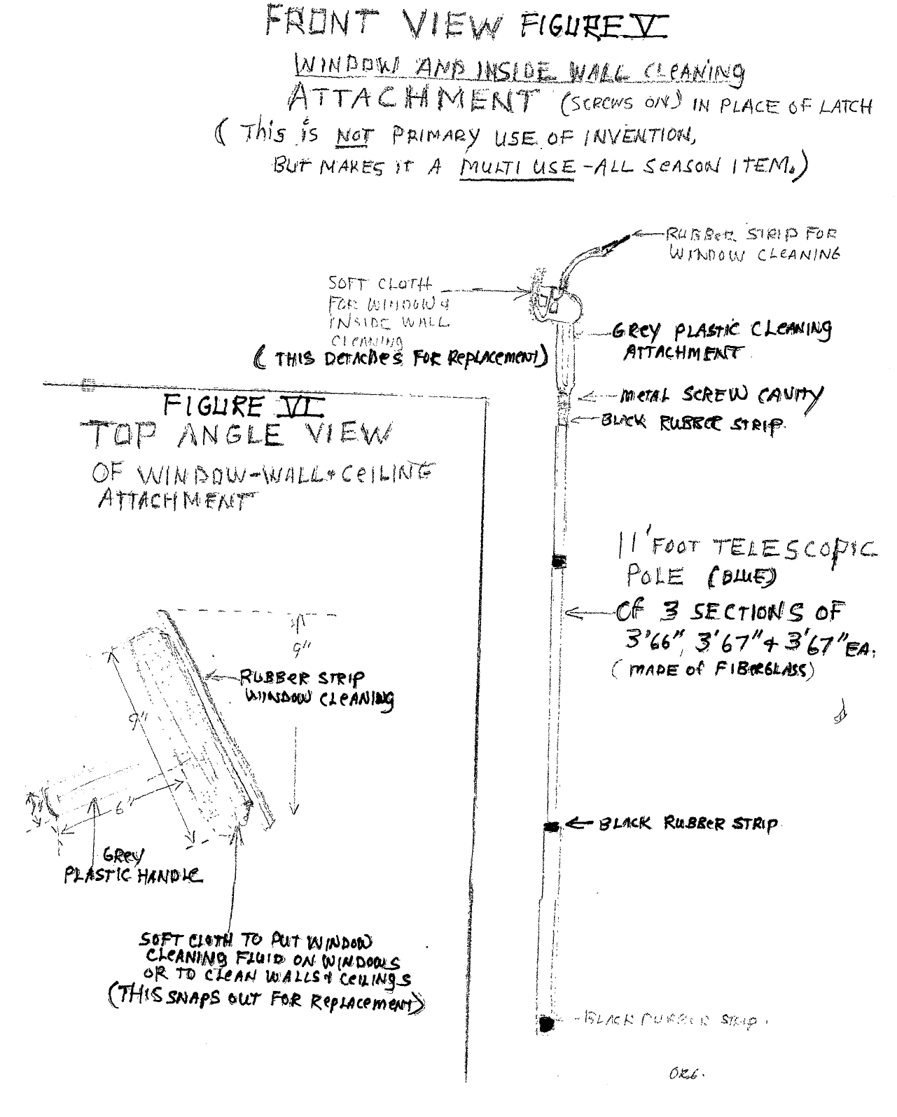

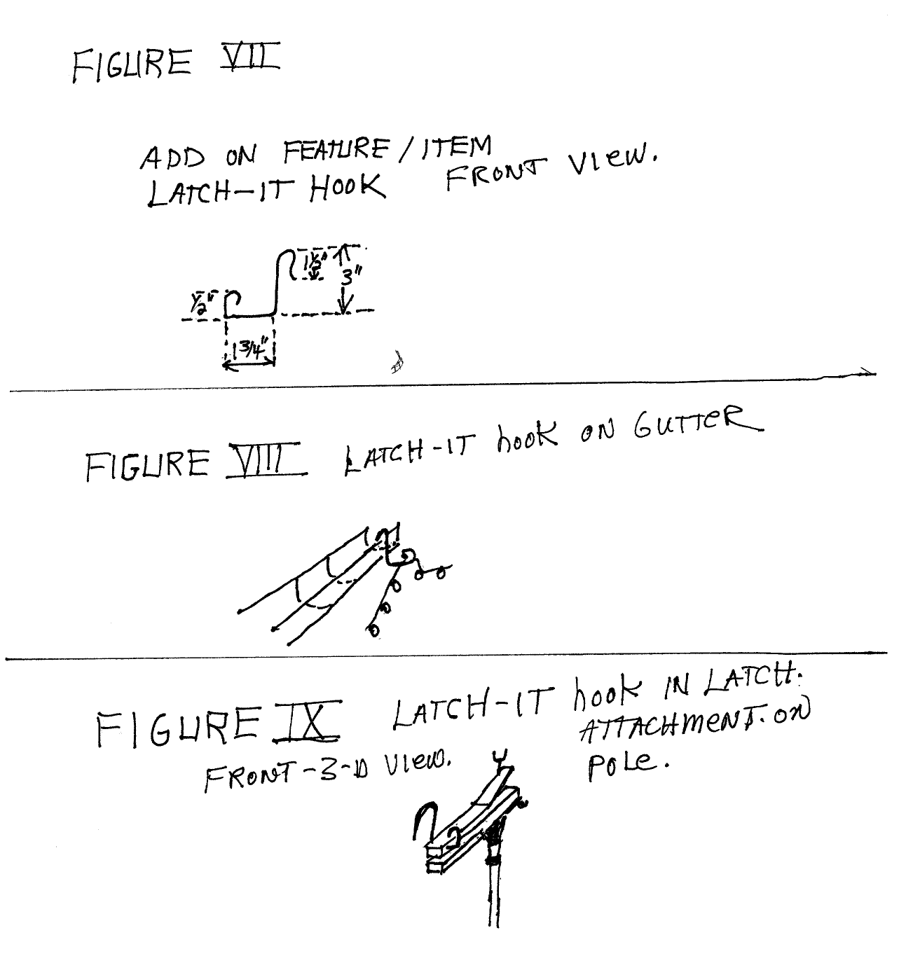

### DESCRIPTION OF INVENTION

This invention hangs Christmas lights and other items in high hard to reach places. It also cleans gutters with a unique innovative latch attachment which is one of two attachments; this being the primary one. Screwing into the top of an 11′ foot 3 section telescopic pole it allows a person to decorate, clean gutters, grab sticks, limbs and other items in high places without using a ladder thus eliminating a safety hazord, saving time and expanding ones decorating and cleaning choices. The unique part of the latch is its sprung closed design at one end and the open design at the opposite end. The closed end allows the user on the ground to open it by pulling the attached rope so they can grab xmas light strings, plus other decorative items and hang in high places with a firm no slipping grip. This end also grabs twigs, limbs and other items/ objects out of gutters and other high hard to reach places. The opposite open end which has a gutter cleaning brush works in reverse. At this end when the attached rope is pulled, it lowers the gutter brush into the gutter to clean. The top part of the latch has a Y hook; can be used for xmas light spacing and quick hanging and take down decorations should the user want to save time and not open and close latch.

A new added item is the latch-it hook. Designed exclusively to work with the decorative end of the latch, it hangs xmas light strings on gutters along with other holiday items in various high hard to reach places. It does this with somewhat of an S shape design. The top part goes on the outside end of gutters to hook into place, the lower part is used for the light strings. This add on would be included in the initial sale of the pole, possibly in packages of 10. Additional ordering and pricing would be opitional.

The other attachment is secondary in use. It cleans windows in high places, along with inside walls and ceilings. This screws into the same 11′ foot telescopic pole. It has a rubber squeegee side and a changable soft cloth side used to apply cleaning liquid when wet and when dry cleans inside walls and ceilings. This attachment may be similar to other products which have no patent and only the one use and was only added to give my invention a multi-seasonal use.

My invention, The Light Pole Xmas Decorator+, expands holiday decorating and allows one to clean without the use of ladders making it safer for the consumer along with saving time, Another safety feature is that materials used prevent electrical shock.

### BRIEF DESCRIPTION OF THE VIEWS OF THE DRAWINGS

FIGS. I to IX, Pages I to IV.

Front View FIG. I Shows Entire Invention including 11′ telescopic 3—section locking telescopic pole and the unique tension spring latch attachment. The Gutter cleaning brush is at the open end; the opposite end which is sprung closed, is used for hanging xmas light strings along with other decorative holiday items. The quick guide Y hook showen on the top is for quick use and spacing of lights. The O ring midway on the pole is to steady the rope which is used to open and close the latch.

Top View FIG. II This innovative part is made of wood, metal and rubber along with semi-soft brush. This highlights the quick Xmas Light Guide shaped in a Y on the very top.

Side Angle View FIG. III This shows the latch attachment in more Detail.

3-D View FIG. IV This shows the latch attachment in depth from another direction.

Front View FIG. V This drawing shows the entire 11′ telescopic pole with its secondary use attachment; the window, wall and ceiling cleaning unit.

Top Angle View FIG. VI This is just a closer look at the cleaning unit attachment which screws into the top of pole, once the latch is screwd out.

Front View FIG. VII This drawing shows the latch-it hook and the measurements in the shape of an S; designed to work exclusively with my innovative latch to hang Xmas lights on gutters.

View FIG. VIII This front 3-D view shows how the latch-it hook works on gutters.

Front 3-D View FIG. IX This drawing shows how latch-it hook works with my latch attachment and pole.

What I claim as my invention is:

1. The Light Pole Xmas Decorator+ is a 3 locking section 11′ foot telescopic pole with each section measuring 3′66″, 3′66″ and 3′67″ extending to the 11′ feet height. This has 2-two attachments; the 1'st being my unique innovative latch which is sprung closed at the decorative and pick-up grabing end while at its open end has a gutter cleaning brush. This first and foremost attachment allows the user to hang xmas light strings, wreaths and other decorative holiday items in high places with a firm no slippage grip which permits the user to eliminate the safety hazord of a step ladder along with saving time, not to mention the expansion of holiday decorating especially outside in high trees and other areas.

2. The open end of the latch which has the gutter cleaning brush also allows a person to clean gutters of leafage and other fine blocking material. The opposite closed decorative end now can be used to pick out twigs, small limbs along with other un-wanted material by the pulling the rope to open the latch which then will grab these items when realesed by the rope to discard. This innovative latch attachment is easely opened by a person on the ground by pulling the attached rope; then it automatically springs closed when rope is realeased.

3. Because of the spring tension in a closed nature of the latch, it can be used to get cats out of trees.

4. The 2'nd cleaning attachment screws into the same 11′ foot telescopic pole. This is not the primary use, and was only added to give my invention a multi-purpose and year round use. This attachment is used to clean windows along with inside ceiling and walls that are high so again one can eliminate the use of a ladder if desired.

5. The add on feature called the latch-it hook is specifically designed to work with the decorative end of the primary use latch attachment. This S-shaped hook fits into the latch and on the outside edge of a gutter allowing the user to hang strings of xmas lights on the edge of gutters. It can also be used to hang other Decorative items such as wreaths in high hard to reach places using the 11′ foot pole and latch attachment.
